(19) United States
(12) Patent Application Publication
(10) Pub. No.: US 2011/0025917 A1
(43) Pub. Date: Feb. 3, 2011

(54) VIDEO PROCESSING DEVICE

(75) Inventor: Mitsuhiro HONME, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi (JP)

(21) Appl. No.: 12/843,285

(22) Filed: Jul. 26, 2010

(30) Foreign Application Priority Data
Jul. 29, 2009 (JP) 2009-176766

(51) Int. Cl. H04N 5/14

(52) U.S. Cl. 348/571; 348/E05.001

(57) ABSTRACT

A video processing device includes a sprite rendering processor in connection with a display buffer (e.g. line buffers) and an alpha table. The sprite rendering processor alternately performs first rendering based on sprite attribute data and second rendering based on alpha attribute data. The first rendering is performed via alpha blending on video data of sprites, rendering-destination video data of the display buffer, and rendering-destination alpha data of the alpha buffer which are produced via the second rendering with the alpha buffer, thus producing resultant video data, which is written over rendering-destination video data in the display buffer. One type of sprite is connected with at least one alpha table which describes alpha data ranging from perfect transparency and perfect non-transparency and which is optimized to demonstrate an anti-aliasing effect on the boundary of a colored region of each sprite on the screen of a visual display.

### BACKGROUND OF THE INVENTION

1. Field of the Invention

The present invention relates to video processing devices employing video data of sprites, e.g. moving elements of graphical objects used in video games, displayed on screens of visual displays.

The present application claims priority on Japanese Patent Application No. 2009-176766 (Filing Date: Jul. 29, 2009), the content of which is incorporated herein by reference.

2. Description of the Related Art

Conventionally-known video processing devices employing sprites need to perform rendering on display buffers storing video data of sprites, which are displayed on screens of visual displays.

Alpha blending is a known technique for rendering sprites with video processing devices. Alpha blending refers to color values representing the brightness or intensity of primary colors, i.e. red (R), green (G), and Blue (B), in pixels with respect to a source picture (i.e. an original picture subjected to alpha blending) and a destination picture (i.e. a background picture dedicated to the rendering of the source picture) as well as alpha data representing the transparency of each pixel. Based on color values and alpha data, alpha blending calculates color values of pixels with respect to a rendering-completed picture in which the source picture is embedded in the destination picture, or it calculates color values of pixels in overlapped areas in which the source picture overlaps the destination picture. A concrete explanation of alpha blending will be given with reference to FIG. 9, in which SC denotes a color value of one pixel constituting the source picture (or one source pixel), and D denotes a color value of one pixel constituting the destination picture (or one destination pixel), wherein the destination picture is dedicated to the rendering of the source picture. A color value D′ of a rendering-completed destination pixel is calculated via Equation (1).

D′=(1−α)·SC+α·D (1)

The above calculation makes it possible to produce a rendering-completed picture which visualizes the destination picture prior to rendering through the source picture with the transparency designated by alpha data.

Alpha blending is not only used as a visual effect visualizing a back-side picture through a front-side picture, but also as an anti-aliasing filter rendering quality outlines of sprites. Next, alpha blending serving as an anti-aliasing filter will be described with reference to FIGS. 10A to 10D.

FIG. 10A shows an example of sprite data subjected to rendering; FIG. 10B shows an example of background data representing a background dedicated to the rendering of sprite data. Sprite data are produced by sampling an analog picture (i.e. an original picture having continuity in visual presentation) via a matrix of multiple pixels. With respect to a boundary in proximity to an outline encompassing a colored region of the analog picture, pixels positioned inwardly of the outline are painted with the color of the colored region, while pixels positioned outside of the outline are blank (or no color). That is, a jagged boundary is formed between the inside and the outside of the colored region with “sampled” sprite data of FIG. 10A, in which the colored region is pained black.

The anti-aliasing filter is used to smooth the outline of the colored region by smoothing out the jagged boundary. Specifically, the anti-aliasing filter performs alpha blending by use of sprite data of FIG. 10A, background data of FIG. 10B, and an alpha table of FIG. 10C collecting various alpha data applicable to pixels.

In the alpha table of FIG. 10C, “0h” (where “h” is an operator representing hexadecimal notation) designates “perfect nontransparent” alpha data, which visualize only the color of a sprite but do not visualize the color of a background, in connection with pixels positioned perfectly inside the outline of the colored region of the analog picture. In addition, “Fh” designates “perfect transparent” alpha data, which visualize the color of a background but do not visualize the color of a sprite, in connection with pixels positioned perfectly outside the outline of the colored region of the analog picture. Further, “8h”, “6h”, “3h”, . . . whose values are set between “0h” and “Fh” designate “intermediate” alpha data in connection with pixels traversing across the outline of the colored region of the analog picture. FIG. 10E shows an example of alpha data representing a pixel traversing across the outline of the colored region, i.e. a block divided into two sections (namely, an inner area “a” and an outer area “b”) with an edge (corresponding to the outline of the colored region). That is, intermediate alpha data is determined in transparency based on the ratio “b/a” between the inner area “a” and the outer area “b” divided with the edge. Alpha data having a high ratio b/a is increased toward “Fh” so as to intensify the background, while alpha data having a low ratio b/a is decreased toward “0h” so as to intensify the sprite. FIG. 10D shows an alpha-blending-completed picture in which the boundary between the colored region of the sprite and the background is smoothly varied in coloring so as to smooth out the jagged outline of the colored region.

Patent Documents 1 and 2 disclose alpha blending serving as anti-aliasing filters.

Patent Document 1: Japanese Patent Application Publication No. 2004-213464

Patent Document 2: Japanese Patent Application Publication No. 2008-198065

Conventionally-known video processing devices employing sprites are designed to use a single alpha table per one type of sprite; hence, alpha blending is performed using a single alpha table dedicated to the rendering of one type of sprite. Since conventionally-known video processing devices are equipped with alpha tables inseparably ascribed to sprites, they are limited in the range of rendering via alpha blending. Since a single sprite table is dedicated to one type of sprite, it is difficult to adequately demonstrate an anti-aliasing effect even when alpha blending is used as an anti-aliasing filter. This drawback occurs when expanding or reducing sprites via rendering. Patent Document 2 may handle this drawback by expanding or reducing alpha tables in conformity with expanded sizes of sprites or reduced sizes of sprites, wherein rendering is performed on expanded sprites or reduced sprites with references to expanded alpha tables or reduced alpha tables. Although alpha tables are expanded or reduced in conformity with expanded sizes of sprites or reduced sizes of sprites, areas of intermediate alpha data (which are intermediate between nontransparent alpha data and transparent alpha data) do not overlap with jagged boundaries of colored regions of expanded or reduced sprites; hence, it is difficult to adequately achieve an anti-aliasing effect.

### SUMMARY OF THE INVENTION

It is an object of the present invention to provide a video processing device which improves alpha blending so as to achieve rich variations in rendering.

A video processing device of the present invention is constituted of a display buffer that stores video data displayed on the screen of a visual display, an alpha buffer that stores alpha data for use in alpha blending on video data involved in rendering in units of pixels, and a sprite rendering processor that alternately performs first rendering and second rendering. The first rendering is performed via alpha blending on video data of sprites, rendering-destination video data of the display buffer, and rendering-destination alpha data of the alpha buffer which are produced via the second rendering with the alpha buffer, thus producing resultant video data, which is written over rendering-destination video data in the display buffer.

The video processing device is equipped with an attribute data table that stores sprite attribute data representing rendering conditions of sprites with respect to the first rendering, and alpha attribute data representing rendering conditions of alpha data with respect to the second rendering.

Since the second rendering of alpha data is performed independently of the first rendering of video data of sprites, it is possible to arbitrarily change alpha data which are used for alpha blending between sprites and its background pictures. Thus, it is possible to produce a wide variety of rendering using alpha blending on the screen of a visual display.

### BRIEF DESCRIPTION OF THE DRAWINGS

These and other objects, aspects, and embodiments of the present invention will be described in more detail with reference to the following drawings.

FIG. 1 is a block diagram showing the constitution of a video processing device according to the preferred embodiment of the present invention.

FIG. 2 shows the stored content of a pattern memory serving as an external memory coupled to the video processing device.

FIG. 3 is a block diagram partly showing the internal constitution of a sprite rendering processor shown in FIG. 1.

FIG. 4 is a flowchart showing the processing of one-line rendering which the sprite rendering processor executes in each horizontal scanning period.

FIG. 5A shows a working example of the stored content of an attribute data table shown in FIG. 1.

FIG. 5B shows rendering-completed sprites and alpha tables two-dimensionally displayed on the display screen of an LCD shown in FIG. 1.

FIG. 5C shows line segments of rendering-completed sprites and alpha tables in connection with one horizontal scanning line via different layers.

FIG. 6 is an illustration explaining a first working example of alpha blending according to the present embodiment.

FIG. 7 is an illustration explaining a second working example of alpha blending according to the present embodiment.

FIG. 8 is an illustration explaining a third working example of alpha blending according to the present embodiment.

FIG. 9 is an illustration explaining conventionally-known alpha blending of sprite data.

FIG. 10A shows a matrix of sampled sprite data subjected to rendering.

FIG. 10B shows a matrix of background data dedicated to the rendering of sprite data.

FIG. 10C shows a matrix of an alpha table storing alpha data used for alpha blending serving as an anti-aliasing filter.

FIG. 10D shows a matrix of an alpha-blending-completed picture.

FIG. 10E shows an example of alpha data applied to a block split into two sections with an edge.

### DESCRIPTION OF THE PREFERRED EMBODIMENT

The present invention will be described in further detail by way of examples with reference to the accompanying drawings.

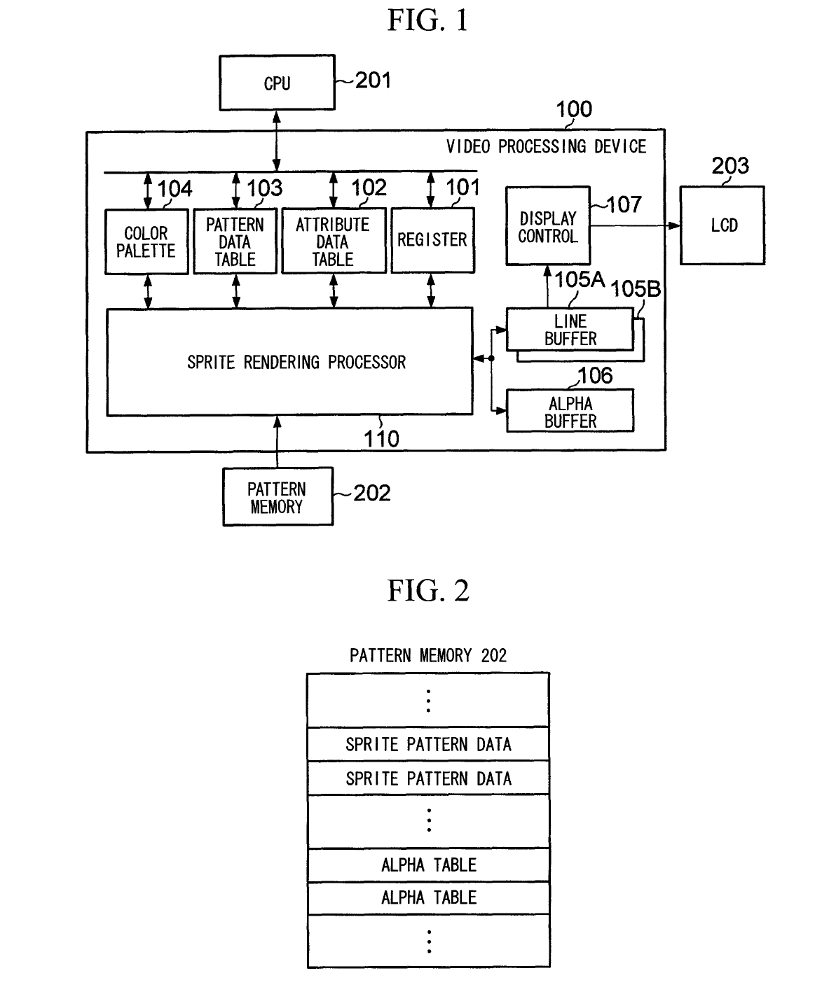

FIG. 1 is a block diagram showing the constitution of a video processing device 100 according to the preferred embodiment of the present invention.

Upon receipt of an instruction from a CPU 201, the video processing device 100 reads sprite pattern data from a pattern memory 202 (i.e. an external memory such as a ROM) so as to produce video data, which are displayed on a screen of a liquid crystal display (LCD) 203. As shown in FIG. 2, the pattern memory 202 stores various sprite pattern data and various types of alpha tables used for alpha blending.

Conventionally-known video processing devices employ one-to-one correspondence between sprites and alpha tables. In contrast, the video processing device 100 of the present embodiment does not necessarily need one-to-one correspondence between sprite pattern data and alpha tables stored in the pattern memory 202. It is possible to store multiple types of alpha tables in correspondence with one type of sprite pattern data in the pattern memory 202. Alternatively, it is possible to additionally store alpha tables dedicated to unspecified sprite pattern data in the pattern memory 202. The present embodiment does not impose restrictions on the correspondence between sprite pattern data and alpha tables, thus making it possible to freely select alpha tables for use in alpha blending in rendering sprites.

Next, the constitution of the video processing device 100 will be described in detail. A register 101 stores control information controlling several parts of the video processing device 100. The CPU 201 and a sprite rendering processor 110 of the video processing device 100 write the control information into the register 101.

An attribute data table 102 (e.g. a RAM) stores sprite attribute data and alpha attribute data. Sprite attribute data designate rendering conditions of sprites, while alpha attribute data designate rendering conditions of alpha tables. The present embodiment is characterized in that alpha tables are subjected to rendering according to alpha attribute data independently of sprites, wherein a lower layer (representing a picture which precedes the alpha table in rendering) and an upper layer (representing a picture which is succeeded by the alpha table in rendering) are subjected to alpha blending. Details will be discussed later.

One sprite attribute data designating one rendering condition of each sprite is a collection of information such as a display position of the sprite in a display screen of the LDC 203 (e.g. an upper-left top position of the sprite), a pattern memory address designating a storage area of sprite pattern data in the pattern memory 202, X-direction and Y-direction dimensions of the sprite, and an expansion/reduction factor of the sprite. One alpha attribute data designating one rendering condition of each alpha table is a collection of information such as a position of an area adopting the alpha table in the display screen of the LCD 203 (e.g. an upper-left top position of an area adopting the alpha table), a pattern memory address designating a storage area storing the alpha table in the pattern memory 202, X-direction and Y-direction dimensions of the alpha table, and an expansion/reduction factor of the alpha table.

A pattern data decoder 103 reads sprite pattern data (involved in rendering) from the pattern memory 202 so as to decode them into video data representing colors of pixels constituting sprites.

A color palette 104 is used in light of color codes designating colors of pixels of sprite pattern data (involved in rendering). The color palette 104 serves as a conversion table for converting sprite pattern data into video data of sprites (i.e. sprite data) representing the brightness or intensity of color components of pixels by way of the predetermined color representation consisting of three color components such as R, G, B and Y, U, V. The CPU 201 is able to update the content of the color palette 104.

Line buffers 105A and 105B store video data which are displayed on the screen of the LCD 203, wherein they have the same storage capacity for storing video data of one line (or one horizontal scanning line). Specifically, one of the line buffers 105A is exclusively used for rendering, while the other is exclusively used for displaying video data. They switch over their functions every time one horizontal scanning line is switched over to the next horizontal scanning line, thus interchanging a “rendering” line buffer and a “display” line buffer. One line buffer serving as a “rendering” line buffer is allocated to rendering of video data.

An alpha buffer 106 stores alpha data which are used to perform alpha blending with video data of one horizontal scanning line (stored in the rendering line buffer) and video data involved in rendering. The alpha buffer 106 includes a plurality of areas storing alpha data in connection with a plurality of pixels constituting one horizontal scanning line. The alpha buffer 106 serves as a rendering destination of each alpha table.

A display control unit 107 generates synchronizing signals such as vertical synchronizing signals VSYNC_N and HSYNC_N, which are used for display control on the LCD 203, so as to supply them to the LCD 203 and the sprite rendering processor 110. In addition, the display control unit 107 reads video data of one horizontal scanning line (constituting a plurality of pixels) from the display line buffer so as to supply them to the LCD 203 in each horizontal scanning period.

The sprite rendering processor 110 performs first rendering or second rendering in accordance with sprite/alpha attribute data which are written into the attribute data table 102 under the control of the CPU 201. In the first rendering, the sprite rendering processor 110 produces sprite data designated by sprite attribute data of the attribute data table 102 so as to store them in the rendering line buffer (i.e. one of the line buffers 105A and 105B). In the second rendering, the sprite rendering processor 110 stores alpha data of the alpha table designated by alpha attribute data of the attribute data table 102 in the alpha buffer 106. In the first rendering, the sprite rendering processor 110 performs alpha blending using alpha data of the alpha buffer 106 together with rendering of sprite data.

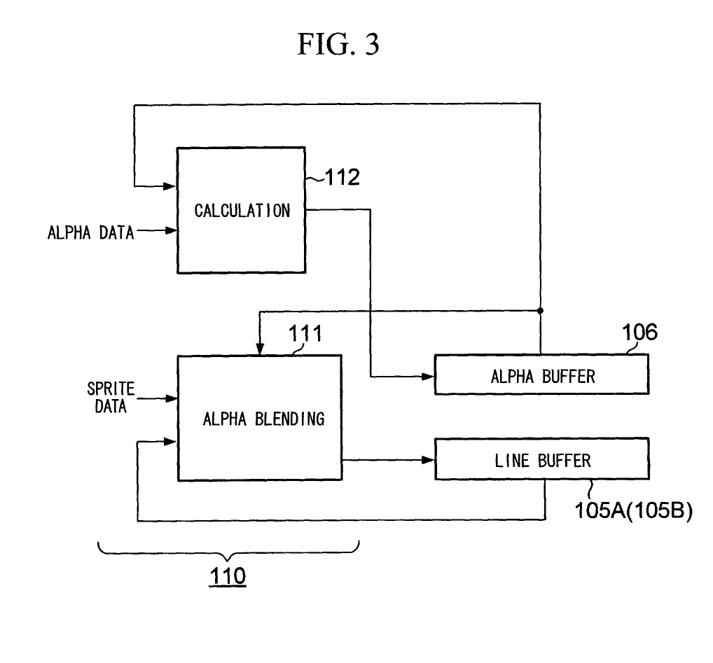

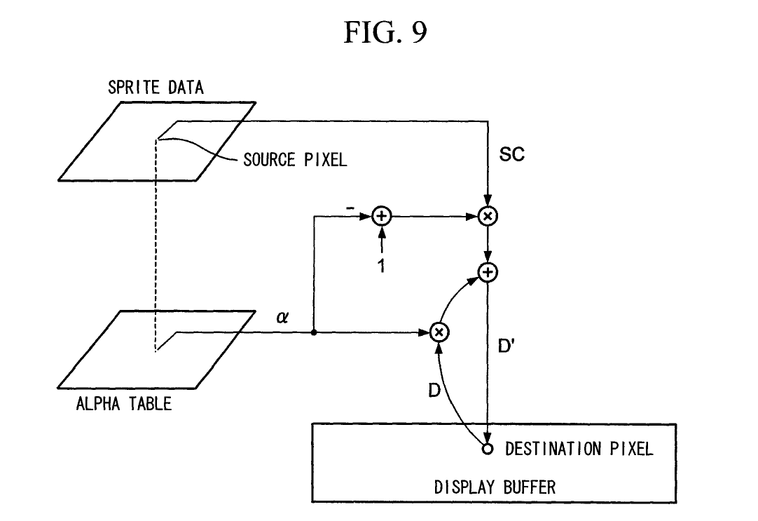

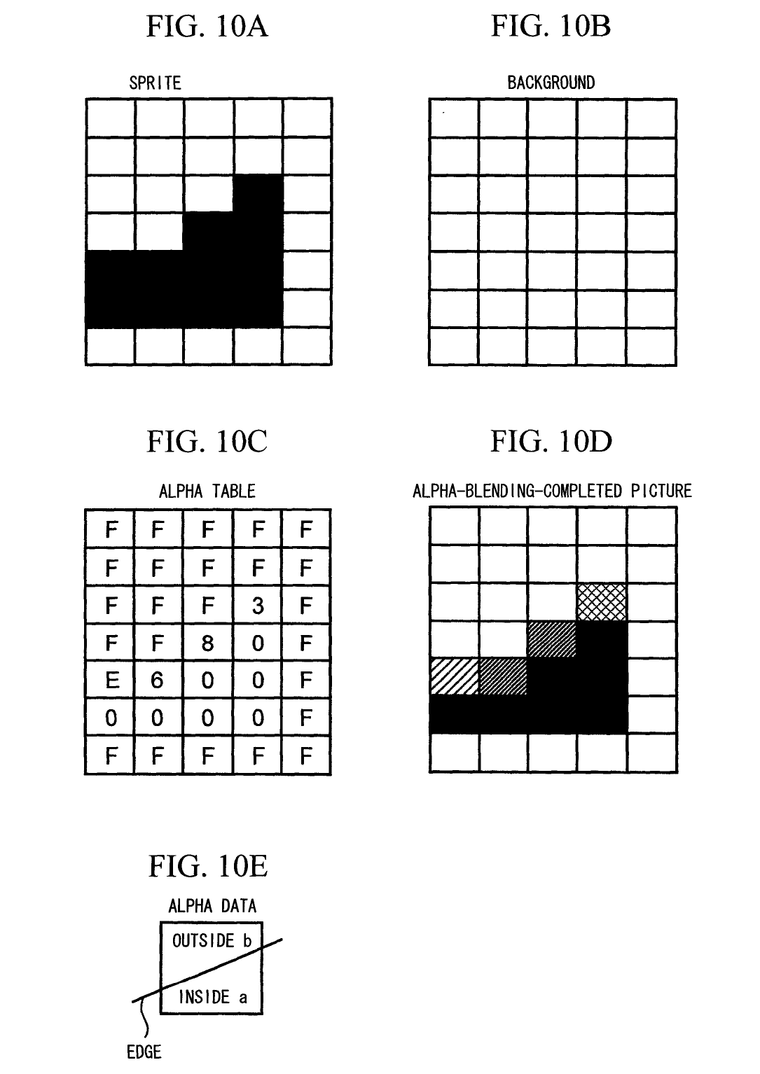

FIG. 3 is a block diagram partly showing the internal constitution of the sprite rendering processor 110. To illustrate the processing of the sprite rendering processor 110 in an understandable manner, the line buffer 105A (105B) and the alpha buffer 106 are additionally shown in FIG. 3. As shown in FIG. 3, the sprite rendering processor 110 includes an alpha blending unit 111 and a calculation unit 112. The alpha blending unit 111 performs alpha blending in the first rendering; hence, the overall processing thereof is basically identical to the foregoing processing explained in FIG. 9. The calculation unit 112 inputs alpha data of a certain alpha table with respect to the second rendering, so that it performs calculations with input alpha data and destined alpha data (serving as a rendering destination of received alpha data) among alpha data of the alpha buffer 106, thus producing calculation result of alpha data. The calculation result of alpha data is written over destined alpha data in the alpha buffer 106.

The sprite rendering processor 110 performs the first rendering or the second rendering by means of the alpha blending unit 111 and the calculation unit 112. Detailed procedures will be described below.

### 1. First Rendering

In the first rendering, the alpha blending unit 111 executes the following tasks a1 to a4.

(a1) Read rendering-destination video data (i.e. video data allocated to an area of rendering destination) with respect to sprite data (i.e. video data of sprites which will be displayed on one horizontal scanning line in the next horizontal scanning period) among video data of the rendering line buffer.
(a2) Read alpha data corresponding to the same pixels as rendering-destination video data among alpha data of the alpha buffer 106.
(a3) Perform alpha blending with sprite data, rendering-destination video data, and alpha data read from the alpha buffer 106, thus producing resultant video data, which are written over video data of the rendering line buffer.
(a4) Set alpha data dedicated to alpha blending (i.e. alpha data corresponding to the same pixels as rendering-destination video data among alpha data of the alpha buffer 106) to “0” representing “perfect transparency”.

### 2. Second Rendering

In the second rendering, the calculation unit 112 executes the following tasks b1 and b2.

(b1) Read rendering-destination alpha data from the alpha buffer 106.
(b2) Write alpha data involved in rendering over rendering-destination alpha data whose value is zero in the alpha buffer 106. Alternatively, write a multiplication result of alpha data, in which alpha data involved in rendering is multiplied by rendering-destination alpha data, over rendering-destination alpha data whose value is not zero in the alpha buffer 106.

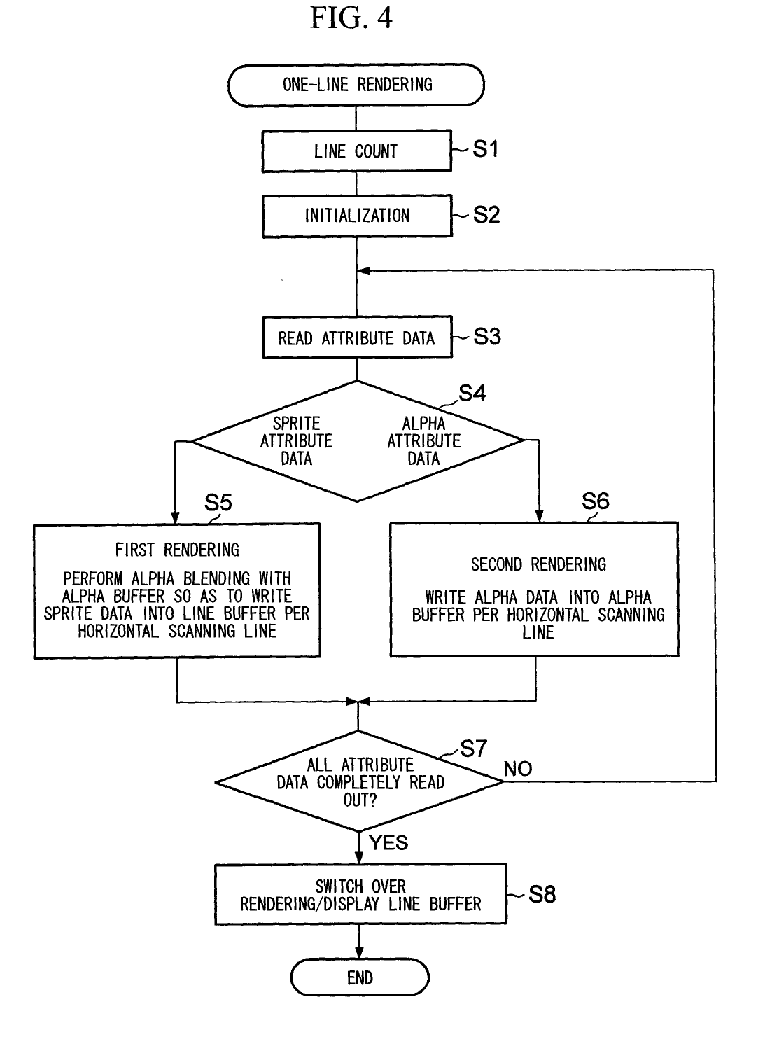

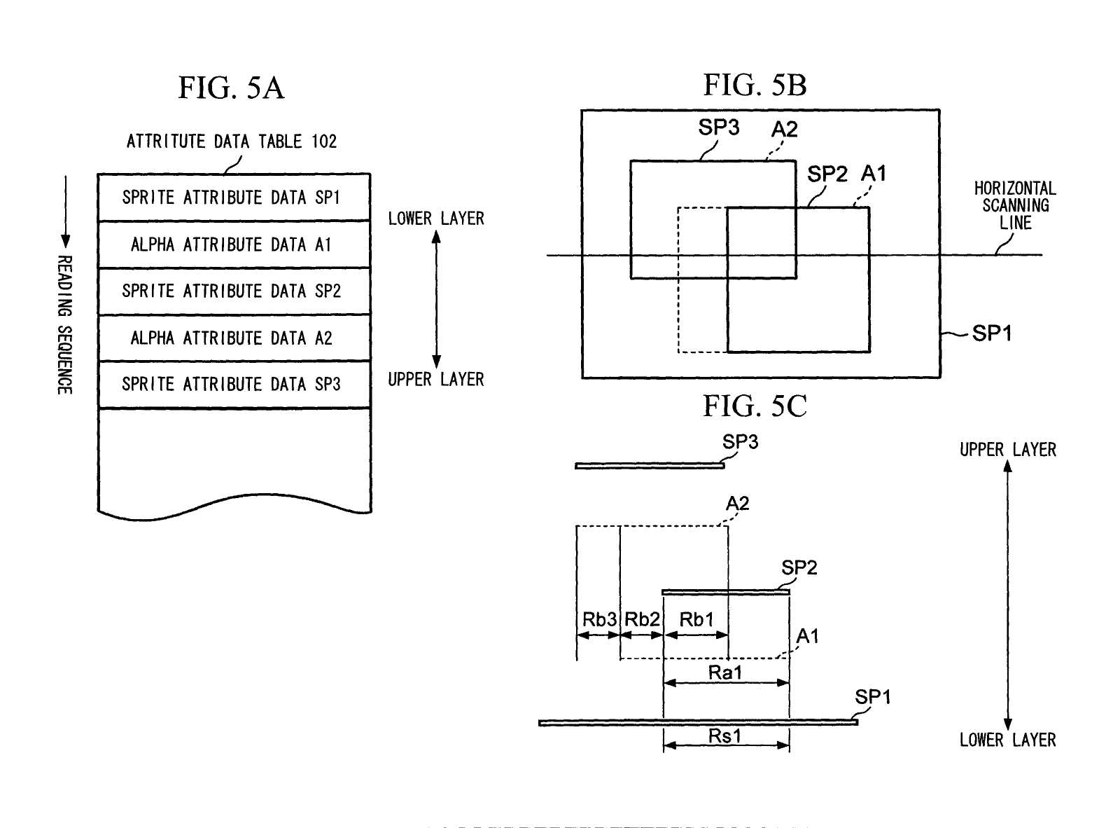

The sprite rendering processor 110 executes one-line rendering every time the display control unit 107 outputs one horizontal synchionizing signal HSYNC_N. FIG. 4 is a flowchart showing the processing of one-line rendering of the sprite rendering processor 110. In FIG. 4, the first rendering is performed in step S5, and the second rendering is performed in step S6. FIGS. 5A to 5C illustrate a working example of the first rendering and the second rendering executed by the sprite rendering processor 110. Next, the details of the processing of the present embodiment will be described with reference to FIG. 4 and FIGS. 5A to 5C.

The sprite rendering processor 110 starts the one-line rendering in connection with the issuance of horizontal synchronizing signals HSYNC_N, wherein it performs line counting in step S1. Herein, the sprite rendering processor 110 counts the number of horizontal synchronizing signals HSYNC_N after a vertical synchronizing signal VSYNC_N, thus determining the number of the present horizontal scanning line, counted from the uppermost horizontal scanning line on the display screen, in the present horizontal scanning period. In step S2, the sprite rendering processor 110 initializes all the video data of the rendering line buffer with video data of the background color (e.g. white) while initializing all the alpha data of the alpha buffer 106 with “0” representing the perfect non-transparency.

In step S3, the sprite rendering processor 110 reads one attribute data from the attribute data table 102. As shown in FIG. 5A, sprite attribute data and alpha attribute data are sequentially written in the attribute data table 102 under the control of the CPU 201. In step S3, the sprite rendering processor 110 reads “top” attribute data following already-read attribute data in the attribute data table 102.

In step S4, the sprite rendering processor 110 discriminates whether sprite attribute data or alpha attribute data is read from the attribute data table 102 in step S3. When sprite attribute data is read from the attribute data table 102, the sprite rendering processor 110 performs the first rendering in step S5. When alpha attribute data is read from the attribute data table 102, the sprite rendering processor 110 performs the second rendering in step S6. Upon completion of the first rendering of step S5 or the second rendering of step S6, the sprite rendering processor 110 makes a decision as to whether or not it reads all the attribute data from the attribute data table 102 in step S7. When the decision result of step S7 is “NO”, the flow proceeds back to step S3 so that the sprite rendering processor 110 restart to read next attribute data from the attribute data table 102. Subsequently, the sprite rendering processor 110 performs the first rendering of step S5 based on sprite attribute data or the second rendering of step S6 based on alpha attribute data. When the sprite rendering processor 110 completely reads all the attribute data from the attribute data table 102 so that the decision result of step S7 turns to “YES”, it switches over the rendering line buffer and the display line buffer in step S8. Thus, it is possible to complete one-line rendering.

As the attribute data table 102 stores a series of attribute data shown in FIG. 5A, the following tasks are sequentially executed upon one-time execution of the one-line rendering of FIG. 4.

(a) First rendering based on sprite attribute data SP1 (step S5)
(b) Second rendering based on alpha attribute data A1 (step S6)
(c) First rendering based on sprite attribute data SP2 (step S5)
(d) Second rendering based on alpha attribute data A2 (step S6)
(e) First rendering based on sprite attribute data SP3 (step S5)

Video data written into the rendering line buffer 105 according to first rendering and alpha data written into the alpha buffer 106 according to second rendering are referred to as layers. Hence, a plurality of layers is accumulated with the hierarchical relationship therebetween. Considering two types of rendering, data written into the rendering line buffer 105 or the alpha buffer 106 according to preceding rendering are subclassified into lower layers, while data written into the rendering line buffer 105 or the alpha buffer 106 according to subsequent rendering are subclassified into upper layers.

FIG. 5B shows alpha tables and sprite data, which are already subjected to rendering according to a series of attribute data shown in FIG. 5A, as two-dimensional areas on the display screen of the LCD 203. In FIG. 5B, 5P1, SP2, and SP3 designate rendering-completed sprites, which are completed in rendering based on sprite attribute data SP1, SP2, and SP3 and written into the rendering line buffer 105. In addition, A1 and A2 designate rendering-completed alpha tables, which are completed in rendering based on alpha attribute data A1 and A2 and written into the alpha buffer 106.

In the present horizontal scanning period, the sprite rendering processor 110 performs first rendering of step S5 (in the one-line rendering of FIG. 4) so as to generate rendering-completed sprite SP1, SP2, or SP3 belonging to the next horizontal scanning line (corresponding to the next horizontal scanning period subsequent to the present horizontal scanning period). Similarly, the sprite rendering processor 110 performs second rendering of step S6 so as to generate the rendering-completed alpha table A1 or A2 belonging to the next horizontal scanning line (corresponding to the next horizontal scanning period subsequent to the present horizontal scanning period).

FIG. 5C show line segments of rendering-completed sprites and alpha tables (shown in FIG. 5B) in connection with one horizontal scanning line in different layers, i.e. upper and lower layers. Next, a working example of the first rendering of step S5 will be described with respect to the sprite SP2 shown in FIG. 5C.

In the task a1, the sprite rendering processor 110 reads rendering-destination video data Rs1, which serves as a rendering destination for video data of the sprite SP2, from the rendering line buffer 105. In the task a2, the sprite rendering processor 110 reads alpha data Ra1 corresponding to the same pixels as the rendering-destination video data Rs1 from the alpha buffer 106. Specifically, it reads a part of the alpha table A1 shown in FIG. 5C. In the task a3, alpha blending is performed using video data of the sprite SP2 (involved in rendering), rendering-destination video data Rs1, and alpha data Ra1 according to Equation (2), thus producing the alpha-blending result of video data (i.e. alpha-blended video data) Rs1′, which is written over rendering-destination video data Rs1.

Rs1′=(1−Ra1)−SP2+Ra1·Rs1 (2)

In the task a4, alpha data Ra1 used in the alpha blending (i.e. alpha data corresponding to the same pixels as rendering-destination video data Rs1) is set to “0” representing the perfect non-transparency.

Next, a working example of second rendering of step s6 will be described with respect to the alpha table A2 shown in FIG. 5C. In the task b1, the sprite rendering processor 110 reads alpha data Rb1, Rb2, and Rb3 as rendering-destination alpha data with the alpha table A2. Herein, alpha data Rb1 is originally a part of alpha data Ra1 but is used in the alpha blending of the first rendering on the sprite SP2 so that the value thereof is set to “0” in the task a4. Alpha data Rb2 is a part of alpha data of the alpha table A1 but is not used in the alpha blending of the first rendering on the sprite Sp2 so that it retains the original value read from the alpha table A1. Alpha data Rb3 belongs to the area in which alpha data of the alpha table A1 is not subjected to rendering; hence, it is initialized to “0” in step S2. In the task b2, alpha data of the alpha table A2 involved in rendering are written over rendering-destination alpha data Rb1 and Rb3 both having “0”. In addition, alpha data of the alpha table A2 is multiplied by alpha data Rb2 so as to produce the multiplication result of alpha data, which is written over rendering-destination alpha data Rb2 not having “0”.

Subsequently, the first rendering is performed on video data of the sprite SP3 such that alpha blending is performed using rendering-destination alpha data of the alpha buffer 106.

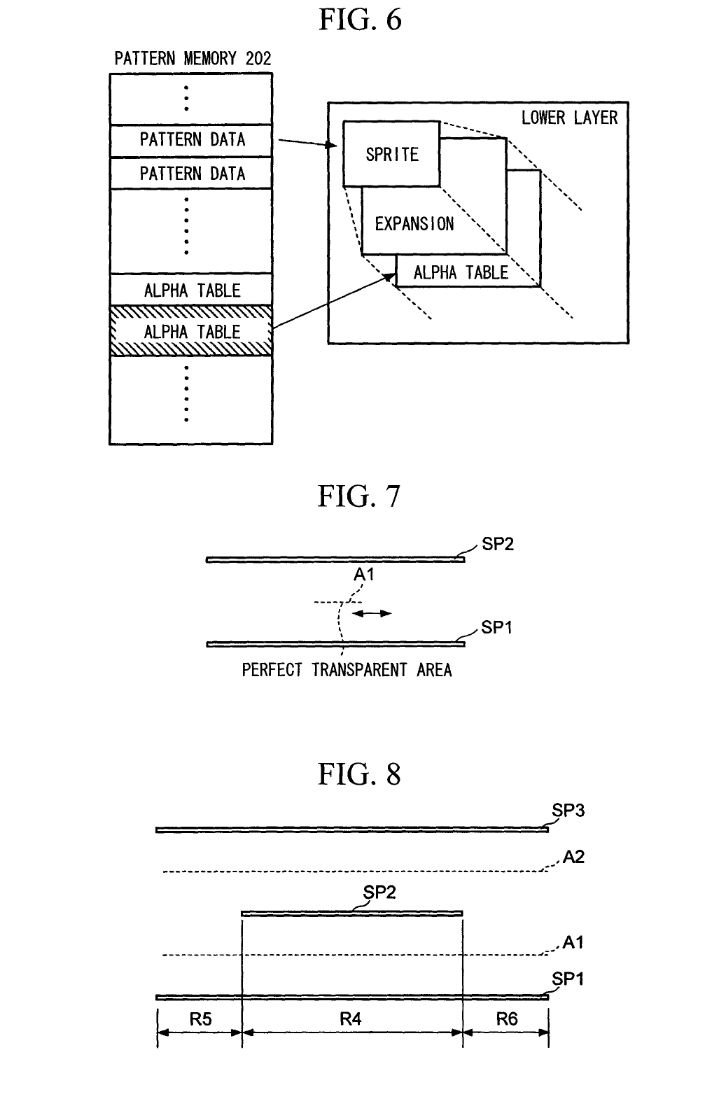

FIG. 6 shows a first working example of alpha blending according to the present embodiment, which achieve an anti-aliasing filter such that a plurality of alpha tables corresponding to various expansion/reduction factors, which are presumed in advance for use in rendering of sprites, is stored in the pattern memory 202 in connection with one type of sprite. Herein, an alpha table pertaining to a single expansion/reduction factor is optimized to adequately demonstrate an anti-aliasing effect such that intermediate alpha data (which are intermediate between the perfect transparency and the perfect non-transparency) completely overlap a jagged boundary of a colored region of a sprite which is expanded or reduced with the expansion/reduction factor.

The attribute data table 102 stores sprite attribute data and alpha attribute data such that, for example, sprite attribute data designating an expansion or a reduction of a sprite with a certain expansion/reduction factor is preceded by alpha attribute data allocating an alpha table of an anti-aliasing filter on the expanded/reduced sprite to the same rendering destination as the expanded/reduced sprite. Thus, it is possible to adequately demonstrate an anti-aliasing effect with respect to expanded/reduced sprites.

FIG. 7 shows a second working example of alpha blending according to the present embodiment, wherein alpha data of perfect transparency in the alpha table A1 are clustered together in a circular-hole perfect transparent area. The CPU 201 writes sprite attribute data and alpha attribute data such that the sprite SP1, the alpha table A1, and the sprite SP2 are sequentially rendered in the one-line rendering of FIG. 4. The CPU 201 rewrites the rendering-destination information regarding alpha attribute data in connection with the alpha table A1 of the attribute data table 102, thus allowing the alpha table A1 to move over a lapse of time. As a result, it is possible to visualize a part of the sprite SP 1 through a circular hole which is opened and moving in the sprite SP2 on the display screen of the LCD 203. That is, the present embodiment is able to change the position of the alpha table which is rendered as the lower layer of the sprite. Thus, it is possible to visualize and change pictures through sprites.

FIG. 8 shows a third working example of alpha blending according to the present embodiment. The CPU 201 writes sprite attribute data and alpha attribute data in the attribute data table 102 such that the sprite SP1, the alpha table A1, the sprite SP2, the alpha table A2, and the sprite SP3 are sequentially rendered in the one-line rendering of FIG. 4. Herein, the sprites SP1, SP3 and the alpha tables A1, A2 have the same size on the display screen so that they are all rendered into the same area. The sprite SP2 is smaller in size than the sprites SP1, SP2 and the alpha tables A1, A2. Each of the sprites SP1, SP3 and the alpha tables A1, A2 includes an area R4 overlapped with the sprite SP2 and areas R5, R6 not overlapped with the sprite SP2.

Upon rendering the sprite SP2, alpha blending is performed on the area R4 according to Equation (3) so as to produce the alpha-blending result of video data SP2′, which is written into the rendering line buffer 105.

SP2′=(1−A1)·SP2+A1·SP1 (3)

Upon rendering the sprite SP3, alpha blending is performed on the area R4 according to Equation (4) so as to produce the alpha-blending result of video data SP3′, which is written into the rendering line buffer 105.

SP3′=(1−A2)·SP3+A2·SP2′=(1−A2)·SP3+A2·{(1−A1)·SP2+A1·SP1}=(1−A2)·SP3+A2·(1−A1)·SP2+A1·SP1 (4)

Alpha data of the alpha table A1 are not used in rendering the sprite SP2 with respect to the areas R5 and R6. Upon rendering the sprite SP3 with respect to the areas R5 and R6, alpha blending is performed using the multiplication result “A2·A1”, which is produced by multiplying “previously-rendered” alpha data of the alpha table A1 by “subsequently-rendered” alpha data of the alpha table A2, according to Equation (5) so as to produce the alpha-blending result of video data SP3′, which is written into the rendering line buffer.

SP3′=(1−A2·A1)·SP3+A2·A1·SP1 (5)

Above Equations (4) and (5) explicitly shows that, upon completion of alpha blending of rendering, the same weight coefficient of A2·A1 is set to both the sprite SP1 of video data SP3′ in the area R4 and the sprite SP1 of video data SP3′ in the areas R5, R6. Thus, it is possible to appropriately adjust a see-through manner of the background visualized through sprites in the areas R4, R5, and R6 on the display screen of the LCD 203. Specifically, the sprite SP1 (serving as the background) is visualized through the other sprites SP2 and SP3, which are aligned in front-back directions, in the area R4 on the display screen, while the sprite SP1 (serving as the background) is visualized through the sprite SP3 in the areas R5 and R6 on the display screen.

### 3. Variations

It is possible to create variations in relation to the present embodiment as follows.
(1) In the second rendering, when alpha blending is performed without using rendering-destination alpha data stilled retained in the alpha buffer 106, the present embodiment multiplies rendering-destination alpha data by another alpha data involved in rendering so as to write the multiplication result of alpha data over rendering-destination alpha data. It is possible to employ other calculations other than multiplication when producing resultant alpha data being written over rendering-destination alpha data. Alternatively, it is possible to prepare multiple types of calculations for producing resultant alpha data based on rendering-destination alpha data and another alpha data involved in rendering, thus writing resultant alpha data over rendering-destination alpha data. Herein, alpha attribute data is able to designate any one of calculations for producing resultant alpha data.
(2) In the second rendering, when alpha blending is performed using alpha data of the alpha buffer 106, the present embodiment sets alpha data to “0” declaring that alpha data of the alpha buffer 106 is used in alpha blending. Instead, it is possible to use one of constituent bits of alpha data as a flag representing a fact as to whether or not alpha data is used in alpha blending. Even when alpha data is used in alpha blending, all bits of alpha data except for the flag are not changed at all; this makes it possible to further utilize “used” alpha data in another alpha blending executed when rendering the upper layer, for example.
(3) It is possible to incorporate a flag, representing whether or not alpha blending is performed in rendering sprites, into sprite attribute data, wherein the flag is used to control execution of alpha blending.
(4) The present embodiment employs various display buffers, i.e. the line buffer 105A, 105B for storing video data in units of lines and the alpha buffer 106 for storing alpha data in units of lines, so that it performs rendering in units of lines. As display buffers, it is possible to employ two frame buffers for storing video data in units of frames and one alpha buffer for storing alpha data in units of frames, whereby rendering is performed in units of frames.
(5) The present embodiment employs the same format for both of alpha tables and video data constituted of color codes. For this reason, it is possible to share common rendering procedures between the first rendering of video data and the second rendering of alpha tables, thus reduce the overall scale of processing in the sprite rendering processor 110.
(6) In the present embodiment, the sprite rendering processor 110 sequentially reads a series of attributer data from the attribute data table 102 in a top-down reading sequence from top attribute data to last attribute data, thus alternately performing the first rendering and the second rendering. For this reason, the attribute data table 102 needs to sequentially store sprite attribute data and alpha attribute data in conformity with the top-down reading sequence. Instead, it is possible to attach rendering numbers to sprite/alpha attribute data being written into the attribute data table 102. Herein, the sprite rendering processor 110 sequentially reading sprite/alpha attribute data from the attribute data table 102 in the order of rendering numbers, thus performing rendering in an appropriate order.

Lastly, the present invention is not necessarily limited to the present embodiment and variations, which can be further modified within the scope of the invention as defined in the appended claims.

What is claimed is:

1. A video processing device comprising:
a display buffer that stores video data displayed on a screen of a visual display;
an alpha buffer that stores alpha data for use in alpha blending on video data involved in rendering in units of pixels; and
a sprite rendering processor that performs first rendering via alpha blending on video data of sprites, rendering-destination video data of the display buffer, and rendering-destination alpha data of the alpha buffer which are produced via second rendering with the alpha buffer, thus producing resultant video data, which is written over the rendering-destination video data in the display buffer.

2. The video processing device according to claim 1 further comprising an attribute data table that stores sprite attribute data representing rendering conditions of sprites and alpha attribute data representing rendering conditions of alpha data, wherein the sprite rendering processor alternately performs the first rendering based on the sprite attribute data or the second rendering based on the alpha attribute data.

3. The video processing device according to claim 1, wherein when the rendering-destination alpha data is still retained in the alpha buffer but is not used in the second rendering, the sprite rendering processor performs a predetermined calculation on the rendering-destination alpha data with another alpha data involved in the second rendering so as to produce the calculation result of alpha data, which is written over the rendering-destination alpha data in the alpha buffer.

4. The video processing device according to claim 3, wherein the rendering-destination alpha data indicating a certain degree of transparency is multiplied with another alpha data involved in the second rendering, so that the multiplication result of alpha data is written over the rendering-destination alpha data in the alpha buffer.

5. The video processing device according to claim 1, wherein one type of sprite is connected with at least one alpha table describing alpha data ranging from perfect transparency and perfect non-transparency.

6. The video processing device according to claim 5, wherein the rendering-destination alpha data indicating the perfect non-transparency is overwritten with another alpha data involved in the second rendering.

7. The video processing device according to claim 5, wherein the alpha table is optimized to demonstrate an anti-aliasing effect on a boundary of a colored region of the sprite on the screen of the visual display.
